(19) United States
(12) Patent Application Publication
(10) Pub. No.: US 2009/0213019 A1
(43) Pub. Date: Aug. 27, 2009

(54) Antenna Device Having A Radome For Installation In A Motor Vehicle

(75) Inventor: Joerg Schoebel, Braunschwerg (DE)

Correspondence Address: KENYON & KENYON LLP, ONE BROADWAY, NEW YORK, NY, 10004, US

(73) Assignee: ROBERT BOSH GMBH, Stuttgart (DE)

(21) Appl. No.: 11/988,702

(22) PCT Filed: May 31, 2006
(86) PCT No.: PCT/EP2006/062795

§ 371 Date: Mar. 17, 2009

(30) Foreign Application Priority Data
Jul. 18, 2005 (DE) 102005033414.8

(51) Int. Cl. H01Q 1/42; H01Q 1/32

(52) U.S. Cl. 343/711; 343/872

(57) ABSTRACT

For an antenna device, in particular for a radar antenna device having excitation field and radome in front of it, the thickness of the radome is varied such that a location-dependent phase delay of the emitted or received wave front may be attained. Thus, tilts, in particular for the non-vertical installation of radar devices in motor vehicles, that lead to unwanted radiation lobe deviations, may be compensated for in a simple way.

### BACKGROUND INFORMATION

The present invention is based on an antenna device, in particular a radar antenna device having in particular a planar excitation field in front of which a radome is disposed.

DE 103 45 314 A1 describes a radar antenna for environment sensing in a motor vehicle. In the case of such a radar antenna, multiple antenna elements are usually disposed one above the other, which elements are triggered within a column and have a fixed phase and amplitude relationship to one another. Thus, in elevation a beam concentration is obtained that serves to increase the range and to mask out unwanted targets that are found at very low or very high altitudes. The antenna elements are disposed in an excitation field in front of which a radome is situated. The installation of such radar antenna arrays puts high demands on size and on form, in particular in the side region. By using planar exciters, such as patch or slot antennas, the array is made flat. Since radar arrays cannot be installed behind the metallic outer walls of a motor vehicle, the installation space remaining in the side region comprises primarily the plastic bumpers, molding, scratch protection elements, impact protection elements, and spoilers stretched around the corners of the vehicle.

Since the outer walls of motor vehicles normally are not exactly vertical, the radar devices must often be installed at an angle because the space available behind paneling such as bumpers, moldings, and the like, is not sufficient for a vertical installation. The resulting deviations of the radiation lobes from the horizontal are compensated for in DE 103 45 314 A1 by installing elements having varying relative permittivity in the signal lines to the antenna exciters or by using mechanically controllable phase shifters in the supply lines for the individual antenna exciters. As an alternative to this, provision is made to produce a phase shift by varying the distance of a conductive element from the waveguide in the supply line to an antenna exciter.

US 2002/0084869 A1 describes the provision of dielectric structures for influencing the wave front and therewith the beam direction.

DE 199 51 123 A1 describes the provision of a Rotman lens to influence the beam characteristics of an antenna excitation field.

### SUMMARY OF THE INVENTION

With the measures in Claim 1, that is, with a variation of the thickness of the radome over the excitation field such that a location-dependent phase delay of the emitted or received wave front may be attained, the beam characteristic may be influenced without requiring that propagation delay elements be set or adjusted. The modification of the phase front of the emitted or received wave occurs purely passively, without electrical measures.

An additional advantage is that a similar excitation field including a triggering system may be used without adjustment for various types of vehicle and/or installation locations. After the assembly of the excitation field including the triggering system, a radome is simply put on whose thickness variation is adjusted to the tilt relative to the vertical. The angle of the radiation lobe relative to the horizontal is accordingly set merely by mounting varying caps (radomes). In the process, all electronic and HF assemblies remain unchanged even as regards their adjustment. This allows for a cost-efficient vehicle-specific manufacturing method.

Further advantageous embodiments are shown in the dependent claims.

### BRIEF DESCRIPTION OF THE DRAWINGS

Exemplary embodiments of the present invention are elucidated in greater detail on the basis of the drawings. The figures show:

FIG. 1 Antenna elements having a radome conventionally arranged in front of them,

FIG. 2 an antenna array according to the present invention having a radome the thickness of which varies linearly,

FIG. 3 a variant of the linear thickness variation of the radome,

FIG. 4 an antenna array according to the present invention having a graduated radome profile,

FIG. 5 an antenna array having a planar antenna column of patch elements,

FIG. 6 an antenna diagram of a planar antenna column without a radome profile according to the present invention,

FIG. 7 an antenna diagram of a planar antenna column having a radome profile according to the present invention.

### DESCRIPTION OF EXEMPLARY EMBODIMENTS

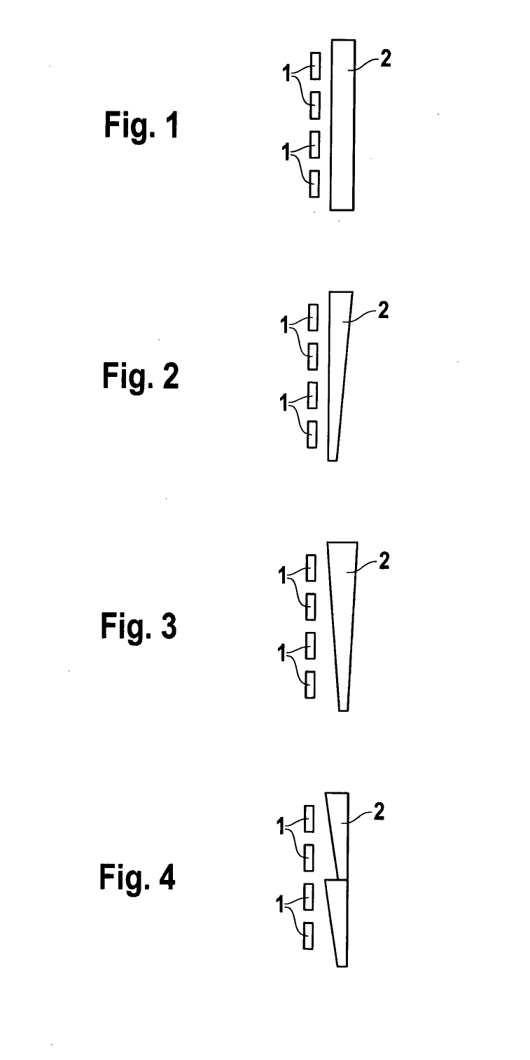

FIG. 1 shows a conventional antenna device having an excitation field made up of four antenna elements 1 that are suitable both for the emission and the reception of electromagnetic waves, in particular radar signals, and, arranged in front of this, a radome 2 of a constant thickness. The emitted wave front appears in-phase on the outer side of the radome. During reception, the wave front received from a direction perpendicular to the surface of the excitation field also appears in-phase on the inner side of the radome, that is, on the side located closest to antenna elements 1.

In the antenna device according to the present invention as shown in FIG. 2, the thickness of radome 2 varies over the excitation field in such a way that during transmission operation a location-dependent phase delay of the emitted wave front may be attained on the outer side of the radome. This makes it possible to influence the direction of the developing radiation lobe. During receiving operation, the wave front, still appearing in-phase on the outer side of the radome, is deflected due to differing propagation delays, in the dielectric of the radome, caused by the varying thickness, so that it arrives at antenna elements 1 at different points in time. However, for a radiation lobe that comes from a particular direction deviating from the surface normal, the signals incident on the antenna elements are in-phase. In the exemplary embodiment shown in FIG. 2, the thickness profile of radome 2 is linear relative to the vertical coordinate. Of course, it can also run linear to a horizontal coordinate.

The antenna structure according to the present invention may also be implemented for an excitation field whose antenna signals are fed in or tapped, for example via a feed network, out of phase and processed further.

FIG. 3 shows an embodiment variant of the linear thickness variation. In contrast to FIG. 2, in which the distance between the antenna elements and the inner side of the radome is constant and in which only the distance between the outer side of the radome and a more distant object increases from top to bottom, here the distance to a distant object is essentially constant, whereas the distance between the inner side of the radome and antenna elements 1 increases from top to bottom. The thickness profile of radome 2 may also, at least partially, increase or decrease in a non-linear way, for example, concave or convex, that is, the wave front additionally appears also bundled or scattered. The thickness variation may be implemented in the elevation and/or in the azimuth direction of the excitation field.

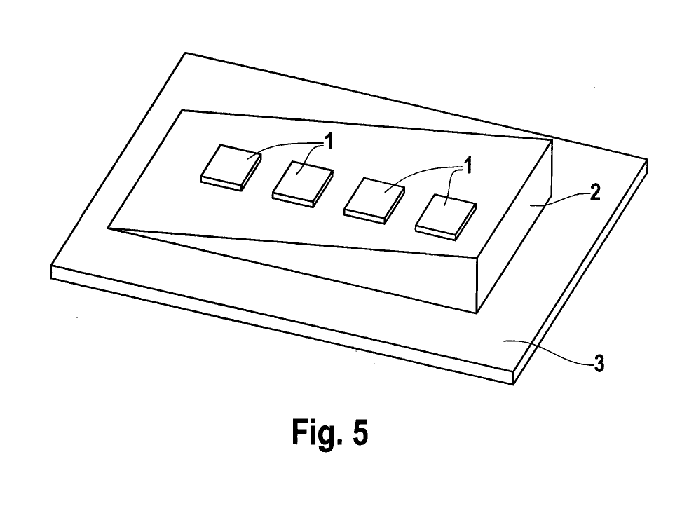

FIG. 4 shows an antenna array having a graduated radome profile, that is, having a thickness profile that is similar to a fresnel lens. Any combinations of thickness profiles may be provided as well.

FIG. 5 shows an antenna device having a planar antenna column made up of four patch antenna elements 1 on a printed-circuit board 3 having a wedge-like radome 2 in front of it whose thickness increases or decreases in a linear fashion. The relative permittivity of the radome (normally plastic) is typically in the range between 2 and 3.

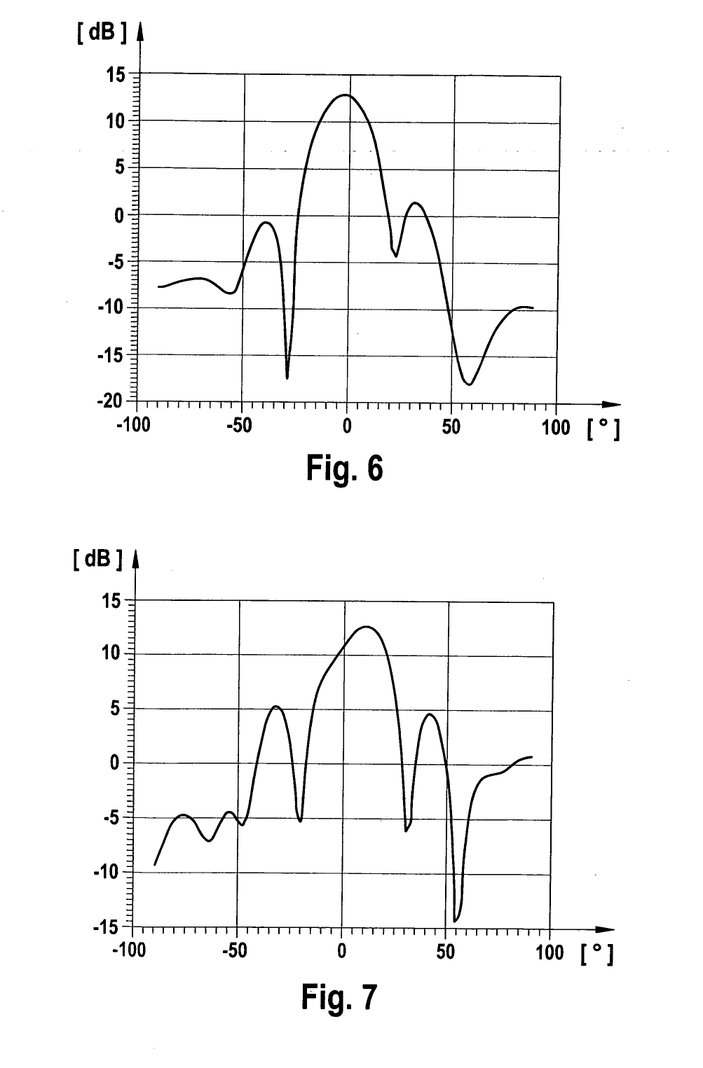

FIG. 6 shows the antenna diagram of a planar antenna column in the elevation direction without a radome; while FIG. 7 shows the relevant antenna diagram having an antenna device according to the present invention having a radome whose thickness varies in a linear way. Radome profiles arranged in front in a wedge-like manner, as shown in FIG. 5, may compensate for the shift, of the radiation lobes from the horizontal, caused by tilting in the case of a non-vertical installation of radar devices.

In FIG. 7, the maximum of the radiation lobe is deflected about 11° from the horizontal.

The antenna device described may be easily integrated into radar sensors that are based on digital beam sweeping or on high-resolution methods, in particular of a location-selective resolution, as are provided for use in the newer generations of LRR (long range radar)/ACC (adaptive cruise control). For such high-resolution angle estimation methods, the correlation properties of the signals on the antenna elements are utilized.

1-9. (canceled)

10. An antenna device comprising:
an excitation field; and
a radome situated in front of the excitation field, wherein a thickness of the radome over the excitation field varies for attaining a location-dependent phase delay of an emitted or received wave front.

11. The antenna device according to claim 10, wherein the antenna device is a radar antenna device.

12. The antenna device according to claim 10, wherein the thickness variation of the radome increases or decreases linearly relative to an elevation or azimuth direction of the excitation field.

13. The antenna device according to claim 10, wherein the thickness variation of the radome increases or decreases linearly in stages relative to an elevation or azimuth direction of the excitation field.

14. The antenna device according to claim 10, wherein the thickness variation occurs, at least partially, additionally in a non-linearly increasing or decreasing fashion relative to at least one of an elevation and azimuth direction of the excitation field.

15. The antenna device according to claim 10, wherein a relative permittivity of the radome is in a range from 2 to 3.

16. The antenna device according to claim 10, wherein the excitation field includes a column of patch elements having a radome having a linearly increasing or decreasing thickness in an elevation direction.

17. The antenna device according to claim 10, wherein the antenna device is for environment sensing in non-vertical installation in a motor vehicle.

18. The antenna device according to claim 17, wherein the excitation field and a triggering system are the same for different types of vehicle and/or installation locations, and a tilting relative to the vertical, which varies in different types of vehicle and/or installation locations, is compensated for by the variation of the thickness of the radome.

19. The antenna device according to claim 10, wherein the antenna device is used for radar devices with at least one of digital beam sweeping and high-resolution angle estimation methods that utilize correlation properties of signals on antenna elements.
